(19) United States
(12) Patent Application Publication
(10) Pub. No.: US 2024/0360369 A1
(43) Pub. Date: Oct. 31, 2024

(54) Processes and Systems for Stabilizing Operation of a Steam Cracker Primary Fractionator

(71) Applicant: ExxonMobil Technology and Engineering Company, Baytown, TX (US)

(72) Inventors: Christopher J. Carr, Houston, TX (US); Tania M. Almazan, Baton Rouge, LA (US); Javier S. Parra, Baton Rouge, LA (US); Andrew J. Rohleder, Baton Rouge, LA (US); David B. Spry, Prairieville, LA (US); Nicholas Contino, Fishers, IN (US)

(21) Appl. No.: 18/625,537

(22) Filed: Apr. 3, 2024

Related U.S. Application Data
(60) Provisional application No. 63/498,669, filed on Apr. 27, 2023.

(51) Int. Cl. C10G 9/36; B01D 3/14

(52) U.S. Cl. CPC C10G 9/36; B01D 3/143; C10G 2300/1037; C10G 2300/1059; C10G 2300/1096; C10G 2300/301; C10G 2300/4081; C10G 2400/06

(57) ABSTRACT

Processes and systems for stabilizing the operation of a steam cracker primary fractionator. In some embodiments, the process can include (I) feeding a first steam cracker effluent into a steam cracker primary fractionator. The process can also include (II) feeding a make-up liquid stream into the steam cracker primary fractionator. The process can also include (III) recovering a steam cracker gas oil (“SCGO”) side stream from the steam cracker primary fractionator. The process can also include (IV) recovering a steam cracker tar (“SCT”) stream from a location at and/or in the vicinity of a bottom of the primary fractionator. The make-up liquid stream can include a first hydrocarbon portion and a second hydrocarbon portion. The first hydrocarbon portion can be distributed into the SCGO side stream. The second hydrocarbon portion can be distributed into the SCT stream.

### CROSS-REFERENCE TO RELATED APPLICATION

This application claims priority to and the benefit of U.S. Provisional Application No. 63/498,669 having a filing date of Apr. 27, 2023, the disclosure of which is incorporated herein by reference in its entirety.

### FIELD

This disclosure generally relates to processes and systems for upgrading a hydrocarbon via steam cracking. More particularly, such processes and systems relate to stabilizing the operation of a steam cracker primary fractionator.

### BACKGROUND

Steam cracker effluents produced by steam cracking a hydrocarbon include saturated hydrocarbons that have been converted to higher value products, e.g., light olefins, such as ethylene and propylene. The products are typically separated via a fractionator commonly referred to as a steam cracker primary fractionator. In addition to the higher value products, other products such as naphtha, gas oil, and quench oil are also recovered via the primary fractionator.

Steam crackers are capable of steam cracking a wide range of feeds that can be gaseous, e.g., a C₄₋ hydrocarbon feed, or liquid, e.g., a C₅₊ hydrocarbon feed, at room temperature. The quantity of liquid hydrocarbons in a steam cracker effluent produced by steam cracking a gaseous hydrocarbon feed is significantly less than the quantity of liquid hydrocarbons in a steam cracker effluent produced by steam cracking a liquid hydrocarbon feed. As such, the design or configuration of a steam cracker primary fractionator configured to receive a steam cracker effluent produced by steam cracking a gaseous hydrocarbon feed is quite different than the design or configuration of a steam cracker primary fractionator configured to receive a steam cracker effluent produced by steam cracking a liquid hydrocarbon feed. Accordingly, to avoid unstable operation of the steam cracking primary fractionator, the hydrocarbon feed introduced into the steam cracker is limited, at least in part, to the design of the steam cracker primary fractionator.

There is a need, therefore, for improved processes and systems for stabilizing the operation of a steam cracker primary fractionator. This disclosure satisfies this and other needs.

### SUMMARY

Processes and systems for stabilizing the operation of a steam cracker primary fractionator are provided. In some embodiments, the process can include (I) feeding a first steam cracker effluent into a steam cracker primary fractionator. The process can also include (II) feeding a make-up liquid stream into the steam cracker primary fractionator. The process can also include (III) recovering a steam cracker gas oil (“SCGO”) side stream from the steam cracker primary fractionator. The process can also include (IV) recovering a steam cracker tar (“SCT”) stream from a location at and/or in the vicinity of a bottom of the primary fractionator. The make-up liquid stream can include a first hydrocarbon portion and a second hydrocarbon portion. The first hydrocarbon portion can be distributed into the SCGO side stream. The second hydrocarbon portion can be distributed into the SCT stream.

In some embodiments, the process can include (1) feeding a first steam cracker effluent produced by steam cracking a first hydrocarbon feed into a steam cracker primary fractionator capable of processing a second steam cracker effluent produced by steam cracking a second hydrocarbon feed, where the second hydrocarbon feed can be heavier than the first hydrocarbon feed. The process can also include (2) feeding a make-up liquid stream into the steam cracker primary fractionator. The process can also include (3) recovering a steam cracker gas oil (“SCGO”) side stream from the steam cracker primary fractionator. The process can also include (4) recovering a steam cracker tar (“SCT”) stream from a location at and/or in the vicinity of a bottom of the primary fractionator. The make-up liquid stream can include a first hydrocarbon portion and a second hydrocarbon portion. The first hydrocarbon portion can be distributed into the SCGO side stream. The second hydrocarbon portion can be distributed into the SCT stream.

In some embodiments, the process can include (i) feeding a first steam cracker effluent into a steam cracker primary fractionator. The process can also include (ii) feeding a make-up liquid stream into the steam cracker primary fractionator, preferably at a location above the first steam cracker effluent. The make-up liquid stream can include a first hydrocarbon portion and a second hydrocarbon portion heavier than the first hydrocarbon portion. The process can also include (iii) recovering a steam cracker gas oil (“SCGO”) side stream that can include the first hydrocarbon portion from the steam cracker primary fractionator. The process can also include (iv) recovering a steam cracker tar (“SCT”) stream that can include the second hydrocarbon portion from a location at and/or in the vicinity of a bottom of the steam cracker primary fractionator. The process can also include (v) feeding at least a portion of the SCGO side stream into a fluidized catalytic cracker (“FCC”). The process can also include (vi) recovering a FCC effluent from the FCC. The process can also include (vii) separating the FCC effluent to obtain a FCC cycle oil stream. The process can also include (viii) providing at least a portion of the FCC cycle oil stream as at least a portion of the make-up liquid stream in step (ii).

### BRIEF DESCRIPTION OF THE DRAWINGS

The subject disclosure is further described in the detailed description that follows in reference to the drawings by way of non-limiting embodiments, in which like reference numerals represent similar parts throughout the several embodiments shown in the drawings.

FIG. 1 depicts an illustrative process/system for separating a steam cracker effluent via a steam cracker primary fractionator into a plurality of products that includes introducing a make-up liquid stream into the primary fractionator, according to one or more embodiments described.

FIG. 2 depicts another illustrative process/system for separating a steam cracker effluent via a primary fractionator into a plurality of products that includes introducing a make-up liquid stream recovered from a fluidized catalytic cracker primary fractionator, according to one or more embodiments described.

FIG. 3 shows exemplary boiling curves of a steam cracker gas oil, a fluidized catalytic cracker light cycle oil, and a steam cracker tar stream.

FIG. 4 shows exemplary boiling curves of a steam cracker gas oil, a fluidized catalytic cracker light cycle oil, a steam cracker tar stream, a heavy coker naphtha stream, a light coker gas oil stream, and a heavy coker gas oil stream.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

In this disclosure, a process is described as including at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Certain embodiments and features are described herein using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

As used herein, the indefinite article “a” or “an” shall mean “at least one” unless specified to the contrary or the context clearly indicates otherwise. Thus, embodiments using “a steam cracking furnace” include embodiments where one, two, or more steam cracking furnaces are used, unless specified to the contrary or the context clearly indicates that only one steam cracking furnace is used.

The term “hydrocarbon” as used herein means (i) any compound consisting of hydrogen and carbon atoms or (ii) any mixture of two or more such compounds in (i). The term “Cn hydrocarbon,” where n is a positive integer, means (i) any hydrocarbon compound comprising carbon atom(s) in its molecule at the total number of n, or (ii) any mixture of two or more such hydrocarbon compounds in (i). Thus, a C2 hydrocarbon can be ethane, ethylene, acetylene, or mixtures of at least two of these compounds at any proportion. A “Cm to Cn hydrocarbon” or “Cm-Cn hydrocarbon,” where m and n are positive integers and m<n, means any of Cm, Cm+1, Cm+2, . . . , Cn−1, Cn hydrocarbons, or any mixtures of two or more thereof. Thus, a “C2 to C3 hydrocarbon” or “C2-C3 hydrocarbon” can be any of ethane, ethylene, acetylene, propane, propene, propyne, propadiene, cyclopropane, and any mixtures of two or more thereof at any proportion between and among the components. A “saturated C2-C3 hydrocarbon” can be ethane, propane, cyclopropane, or any mixture thereof of two or more thereof at any proportion. A “Cn+ hydrocarbon” means (i) any hydrocarbon compound comprising carbon atom(s) in its molecule at the total number of at least n, or (ii) any mixture of two or more such hydrocarbon compounds in (i). A “Cn- hydrocarbon” means (i) any hydrocarbon compound comprising carbon atoms in its molecule at the total number of at most n, or (ii) any mixture of two or more such hydrocarbon compounds in (i). A “Cm hydrocarbon stream” means a hydrocarbon stream consisting essentially of Cm hydrocarbon(s). A “Cm-Cn hydrocarbon stream” means a hydrocarbon stream consisting essentially of Cm-Cn hydrocarbon(s).

The term “hydrocarbon feed” refers to a composition that includes one or more hydrocarbons. In some embodiments, the hydrocarbon feed can be primarily heavy hydrocarbons, e.g., C₅₊ hydrocarbons. In other embodiments, the hydrocarbon feed can be primarily light hydrocarbons, e.g., C₄₋ hydrocarbons. Illustrative hydrocarbon feeds can be or can include, but are not limited to, crude, gas oils, heating oil, jet fuel, diesel, kerosene, gasoline, coker naphtha, steam cracked naphtha, catalytically cracked naphtha, hydrocrackate, reformate, raffinate reformate, Fischer-Tropsch liquids and/or gases, natural gasoline, distillate, virgin naphtha, atmospheric pipestill bottoms, vacuum pipestill streams such as vacuum pipestill bottoms and wide boiling range vacuum pipestill naphtha to gas oil condensates, non-virgin hydrocarbons from refineries, vacuum gas oils, heavy gas oil, naphtha contaminated with crude, atmospheric residue, heavy residue, a C₄/residue admixture, naphtha/residue admixture, hydrocarbon gases/residue admixture, hydrogen/residue admixtures, waxy residues, gas oil/residue admixture, relatively light alkanes, e.g., methane, ethane, propane, and/or butane, recycle streams that can include ethane, propane, ethylene, propylene, butadiene, or a mixture thereof, one or more condensates, fractions thereof, or any mixture thereof.

The term “consisting essentially of” as used herein means the composition, feed, effluent, product, or other stream comprises a given component at a concentration of at least 60 wt %, preferably at least 70 wt %, more preferably at least 80 wt %, more preferably at least 90 wt %, still more preferably at least 95 wt %, based on the total weight of the composition, feed, effluent, product, or other stream in question.

The term “aromatic” as used herein is to be understood in accordance with its art-recognized scope which includes alkyl substituted and unsubstituted mono- and poly-nuclear compounds.

The terms “channel” and “line” are used interchangeably and mean any conduit configured or adapted for feeding, flowing, and/or discharging a vapor, a liquid, and/or a solid into the conduit, through the conduit, and/or out of the conduit, respectively. For example, a composition can be fed into the conduit, flow through the conduit, and can be discharged from the conduit to move the composition from a first location to a second location. Suitable conduits can be or can include, but are not limited to, pipes, hoses, ducts, tubes, and the like.

As used herein, “wt %” means percentage by weight, “vol %” means percentage by volume, “mol %” means percentage by mole, “ppm” means parts per million, and “ppm wt” and “wppm” are used interchangeably to mean parts per million on a weight basis. All concentrations herein are expressed on the basis of the total amount of the composition in question, unless specified otherwise. All ranges expressed herein should include both end points as two specific embodiments unless specified or indicated to the contrary.

### Processes/Systems for Stabilizing Operation of a Steam Cracker Primary Fractionator

A description of the processes/systems of this disclosure will now be made by referencing the non-limiting drawings showing various preferred embodiments.

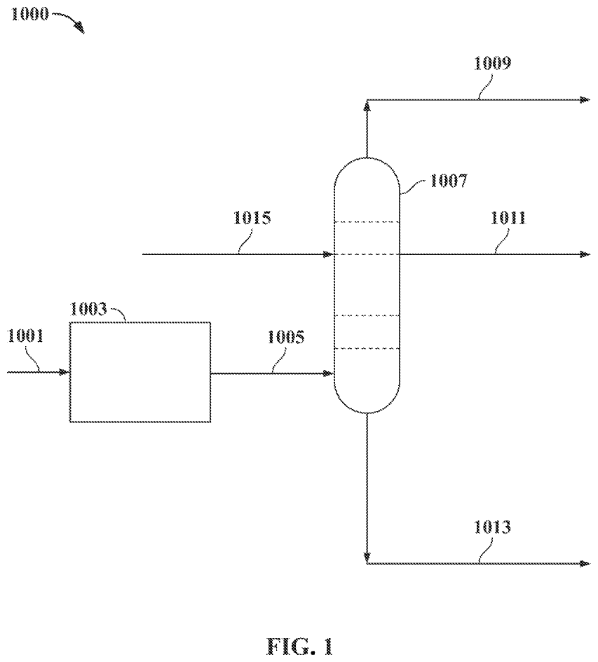

FIG. 1 depicts an illustrative process/system 1000 for separating a steam cracker effluent in line 1005 within a steam cracker primary fractionator 1007 into a plurality of products, e.g., an overhead via line 1009, a steam cracker gas oil (“SCGO”) side stream via line 1011, and a steam cracker tar (“SCT”) stream via line 1013, that includes introducing a make-up liquid stream via line 1015 into the steam cracker primary fractionator 1007, according to one or more embodiments. The steam cracker effluent in line 1005 can be produced by steam cracking a hydrocarbon feed in line 1001 via one or more steam crackers 1003. In some embodiments, the make-up liquid stream via line 1015 can be introduced into the steam cracker primary fractionator 1007 at a location below, equal to, or above the location the steam cracker effluent via line 1005 is introduced into the steam cracker primary fractionator 1007. In some embodiments, the make-up liquid stream via line 1015 can be introduced into the steam cracker primary fractionator 1007 at a location above the location the steam cracker effluent via line 1005 is introduced into the steam cracker primary fractionator 1007. In some embodiments, at least a portion of the make-up liquid stream in line 1015 can be combined with the steam cracker effluent in line 1005 to produce a mixture that can be introduced into the steam cracker primary fractionator 1007.

In some embodiments, additional product streams can be separated from the steam cracker effluent in line 1005 via the steam cracker primary fractionator 1007. For example, in some embodiments, a steam cracker naphtha (“SCN”) side stream and/or a steam cracker quench oil (“SCQO”) side stream can be recovered from the steam cracker primary fractionator 1007. The particular number of product streams and compositions thereof that can be recovered from the steam cracker primary fractionator 1007 can depend, at least in part, on the particular composition of the steam cracker effluent in line 1005 and/or the composition of the make-up stream in line 1015 and/or the internal configuration of the steam cracker primary fractionator 1007.

The make-up liquid stream in line 1015 can include a first hydrocarbon portion and a second hydrocarbon portion. At least a portion of the first hydrocarbon portion in the make-up liquid stream in line 1015 can be distributed into the SCGO side stream recovered via line 1011. At least a portion of the second hydrocarbon portion in the make-up liquid stream in line 1015 can be distributed into the SCT stream recovered via line 1013. In some embodiments, the amount of the first hydrocarbon portion in the make-up liquid stream in line 1015 that can be distributed into the SCGO side stream in line 1011 can be at least 20 wt %, at least 23 wt %, at least 25 wt %, at least 27 wt %, at least 30 wt %, at least 33 wt %, at least 35 wt %, at least 37 wt % or at least 40 wt % of the make-up liquid stream in line 1015, based on the total weight of the make-up liquid stream in line 1015. In some embodiments, the amount of the second hydrocarbon portion in the make-up liquid stream in line 1015 that can be distributed into the SCT stream in line 1013 can be at least 30 wt %, at least 33 wt %, at least 35 wt %, at least 37 wt %, at least 40 wt %, at least 43 wt %, at least 45 wt %, at least 47 wt %, or at least 50 wt % of the make-up liquid stream in line 1015, based on the total weight of the make-up liquid stream in line 1015. In some embodiments, when one or more additional products streams are recovered from the steam cracker primary fractionator 1007, e.g., a SCQO side stream and/or a SCN side stream, a third hydrocarbon portion and/or a fourth hydrocarbon portion can be distributed into the SCN side stream and/or the SCQO side stream, respectively. In some embodiments, when two or more additional products streams are recovered from the steam cracker primary fractionator 1007, e.g., a SCQO side stream and/or a SCN side stream, a third hydrocarbon portion in the make-up liquid stream in line 1015 can be distributed into the SCQO side stream with little to no portion of the make-up liquid stream in line 1015 being distributed into the SCN side stream.

In some embodiments, the make-up liquid stream in line 1015 can include, based on the total weight of the make-up liquid stream, from 5 wt %, 7 wt %, 10 wt %, 12 wt %, 15 wt %, or 17 wt % to 20 wt %, 23 wt %, 25 wt %, 27 wt %, 30 wt %, 33 wt %, or 35 wt % of hydrocarbon molecules having normal boiling points from 145° C. to 260° C. In some embodiments, the make-up liquid stream in line 1015 can include, based on the total weight of the make-up liquid stream, from 5 wt %, 7 wt %, 10 wt %, 15 wt %, or 20 wt % to 25 wt %, 30 wt %, 35 wt %, 40 wt %, or 45 wt % of hydrocarbon molecules having normal boiling points >340° C. As such, in some embodiments, the make-up liquid stream in line 1015 can include, based on the total weight of the make-up liquid stream, from 20 wt %, 25 wt %, 30 wt % 35 wt %, 40 wt %, or 45 wt % to 50 wt %, 55 wt %, 60 wt %, 65 wt %, 70 wt %, 75 wt %, 80 wt %, 85 wt %, or 90 wt % of hydrocarbon molecules having a normal boiling point from >260° C. to <340° C.

In some embodiments, the make-up liquid stream in line 1015 can include ≥80 wt %, ≥83 wt %, ≥85 wt %, ≥87 wt %, or ≥90 wt % of hydrocarbon molecules having normal boiling points in a range from 200° C. to 485° C. In some embodiments, the make-up liquid stream in line 1015 can include 25 wt %, 30 wt %, 35 wt %, 40 wt %, or 45 wt % to 50 wt %, 55 wt %, 60 wt %, 65 wt %, 70 wt %, 75 wt %, or 80 wt % of hydrocarbons having normal boiling points in the range from 260° C. to 345° C.

In some embodiments, the make-up liquid stream in line 1015 can be or can include an ultra-light cycle oil (“ULCO”) stream obtained from a FCC primary fractionator, a light cycle oil (“LCO”) stream obtained from a FCC primary fractionator, a heavy cycle oil (“HCO”) stream obtained from a FCC primary fractionator, a heavy heating oil (“HHO”) stream obtained from a FCC primary fractionator, a heavy catalytic cycle oil (“HCCO”) stream obtained from a FCC primary fractionator, a heavy coker naphtha (“HKN”) stream obtained from a coker primary fractionator, a light coker gas oil (“LKGO”) stream obtained from a coker primary fractionator, a heavy coker gas oil (“HKGO”) stream obtained from a coker primary fractionator, a heavy aromatic reformate (“HAR”) stream obtained from a reformer effluent, or any mixture thereof. The ULCO stream, the LCO stream, the HCO stream, the HHO stream, and the HCCO stream can also be referred to as a FCC cycle oil stream. In some embodiments, the make-up liquid stream in line 1015 can be or can include the LCO stream obtained from the FCC primary fractionator.

In some embodiments, the steam cracker primary fractionator 1007 can be configured to require a minimum production rate for the SCGO side stream in line 1011 and a minimum production rate for the SCT stream in line 1013. In some embodiments, the steam cracker effluent in line 1005 alone can be incapable of achieving the minimum production rate for the SCGO side stream in line 1011 and/or the minimum production rate for the SCT stream in line 1013. For example, in some embodiments, the steam cracker primary fractionator 1007 can be designed to process a steam cracker effluent in line 1005 produced by steam cracking a liquid hydrocarbon feed, e.g., a C₅₊ hydrocarbon feed. As such, when the steam cracker effluent in line 1005 is produced by steam cracking a gaseous hydrocarbon feed, e.g., a C₄₋ hydrocarbon feed, the steam cracker effluent in line 1005 can be incapable of achieving the minimum production rate for the SCGO side stream in line 1011 and/or the minimum production rate for the SCT stream in line 1013, which can cause operation of the steam cracker primary fractionator 1007 to become unstable. For example, a high SCT residence time within the steam cracker primary fractionator 1007, SCT pipelines, pumps, heat exchangers, and/or other process equipment can lead to fouling and coke deposition that can require shutdown of the steam cracker primary fractionator 1007 and/or other process equipment associated therewith for mechanical cleaning. In another example, fouling in the primary fractionator 1007 can also occur if the production rate for the SCGO side stream in line 1011 falls below the minimum production rate.

Feeding the make-up liquid stream via line 1015 into the steam cracker primary fractionator 1007 can stabilize operation of the steam cracker primary fractionator 1007. More particularly, the make-up liquid stream in line 1015 can increase the amount or quantity of liquid hydrocarbons present within the steam cracker primary fractionator 1007 such that the minimum production rate for the SCGO side stream in line 1011 and/or the minimum production rate for the SCT stream in line 1013 can be met and operation of the steam cracker primary fractionator 1007 can be stabilized. It should be understood that, in some embodiments, the make-up liquid stream in line 1015 can be introduced directly into the steam cracker primary fractionator 1007 (as shown) and/or can be mixed with the steam cracker effluent in line 1005 to produce a mixture that can be introduced into the steam cracker primary fractionator 1007 (not shown).

In some embodiments, feeding of the hydrocarbon feed or “first” hydrocarbon feed via line 1001 into the steam cracker 1003 can be stopped and another or “second” hydrocarbon feed via line 1001 can be introduced into the steam cracker 1003, where the second hydrocarbon feed in line 1001 can have a different composition than the first hydrocarbon feed in line 1001. In such embodiment, feeding of the steam cracker effluent or “first” steam cracker effluent via line 1005 into the steam cracker primary fractionator 1007 can be stopped and feeding of another or “second” steam cracker effluent via line 1005 can be started, where the second steam cracker effluent in line 1005 can include different amounts of SCGO and SCT as compared to the first steam cracker effluent in line 1005. In such embodiment, the amount of the make-up liquid stream in line 1015 and/or a composition of the make-up liquid stream in line 1015 can be adjusted to maintain stable operation of the steam cracker primary fractionator 1007. In some embodiments, the second steam cracker effluent fed via line 1005 into the steam cracker primary fractionator 1007 can be capable of achieving the minimum production rate of the SCGO side stream in line 1011 and the minimum production rate for the SCT stream in line 1013. In such embodiment, feeding of the make-up liquid stream via line 1015 into the steam cracker primary fractionator 1007 can be reduced to zero.

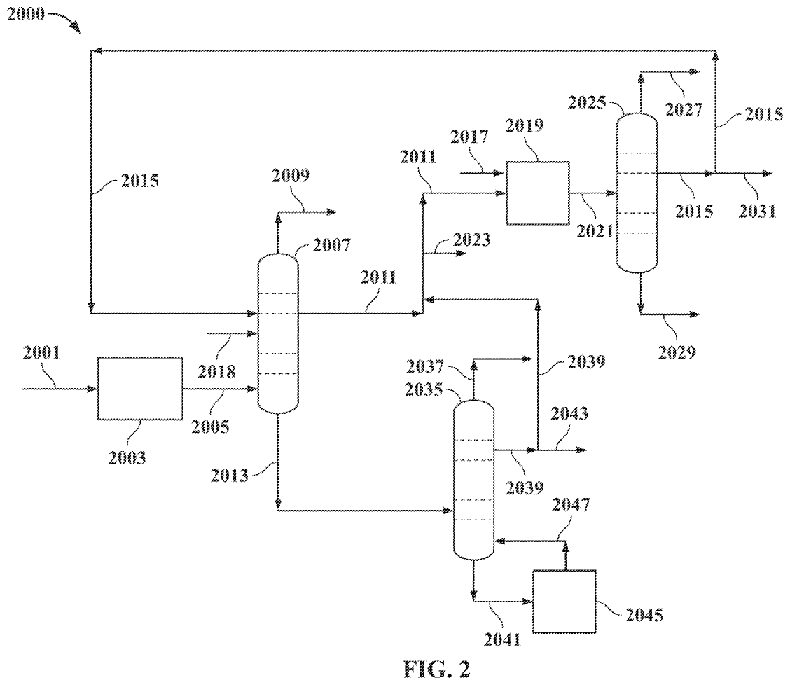

FIG. 2 depicts another illustrative process/system 2000 for separating a steam cracker effluent in line 2005 via a steam cracker primary fractionator 2007 into a plurality of products, e.g., an overhead via line 2009, a SCGO side stream via line 2011, and a SCT stream via line 2013, that includes introducing a make-up liquid stream via line 2015 recovered from a FCC primary fractionator 2025, according to one or more embodiments. In some embodiments, at least a portion of the SCGO stream via line 2011 can be introduced into a FCC reactor 2019. In some embodiments, at least a portion of the SCT stream via line 2013 can be introduced into a coker primary fractionator 2035.

In some embodiments, the steam cracker effluent in line 2005 can be produced by steam cracking a first hydrocarbon feed in line 2001 that can be fed into the steam cracker primary fractionator 2007. The steam cracker primary fractionator 2007 can be capable of processing a second steam cracker effluent in line 2005 produced by steam cracking a second hydrocarbon feed in line 2001, where the second hydrocarbon feed is heavier than the first hydrocarbon feed. For example, in some embodiments, the second hydrocarbon feed can be a C₅₊ hydrocarbon feed and the first hydrocarbon feed can be a C₄₋ hydrocarbon feed. In such embodiment, the make-up liquid stream fed via line 2015 into the steam cracker primary fractionator 2007 can increase the amount or quantity of liquid hydrocarbons present within the steam cracker primary fractionator 2007 such that the minimum SCGO side stream production rate and/or the minimum SCT stream production rate can be met and the steam cracker primary fractionator 2007 can be operated in a stable manner. Without feeding the make-up liquid stream via line 2015 into the steam cracker primary fractionator 2007, the minimum SCGO side stream production rate and/or the minimum SCT stream production rate would not be met and operation of the steam cracker primary fractionator 2007 would become unstable.

In some embodiments, the make-up liquid stream in line 2015 can be a ULCO stream, a LCO stream, a HCO stream, a HHO stream, and/or a HCCO stream obtained from the FCC primary fractionator 2025. In some embodiments, one or more liquid hydrocarbon streams via line 2018, in lieu of or in addition to the make-up liquid stream in line 2015 recovered from the FCC primary fractionator 2025, can be introduced into the steam cracker primary fractionator 2007 to provide at least a portion of the make-up liquid stream introduced thereto. In some embodiments, at least a portion of the additional liquid hydrocarbon stream in line 2018 can be combined with the make-up liquid stream in line 2015 to produce a combined make-up liquid stream that can be introduced into the steam cracker primary fractionator 2007. In other embodiments, at least a portion of the additional liquid hydrocarbon stream in line 2018 can be combined with the steam cracker effluent in line 2005 and introduced into the steam cracker primary fractionator 2007. In some embodiments, the additional liquid hydrocarbon stream that can make-up at least a portion of the make-up liquid stream introduced into the steam cracker primary fractionator 2007 can be or can include, but is not limited to, a HKN stream, a LKGO stream, and/or a HKGO stream obtained from the coker primary fractionator 2035, a HAR stream obtained from a reformer effluent, or any mixture thereof. In some embodiments, the make-up liquid stream in line 2015 can be or can include the LCO obtained from the FCC primary fractionator 2025. In other embodiments, the make-up liquid stream in line 2015 can be or can include the HKN stream, the LKGO stream, the HKGO stream, or any mixture thereof obtained from the coker primary fractionator 2035.

As noted above, in some embodiments, at least a portion of the SCGO side stream via line 2011 can be fed into the FCC reactor 2019 to provide at least a portion of a hydrocarbon feed introduced into the FCC reactor 2019. In some embodiments, one or more additional hydrocarbon streams via line 2017 can also be introduced into the FCC reactor 2019. The FCC reactor 2019 can catalytically crack at least a portion of the SCGO side stream in line 2011 and, if present, at least a portion of the one or more additional hydrocarbon streams in line 2017 to produce a FCC effluent via line 2021.

The FCC effluent via line 2021 can be introduced into the FCC primary fractionator 2025. A number of product streams can be recovered from the FCC primary fractionator 2025. For simplicity and ease of description, a FCC overhead stream via line 2027, a FCC side stream via line 2015, and a FCC bottoms stream via line 2029 are shown. The FCC side stream in line 2015 represents any one or more of the ULCO stream, the LCO stream, the HCO stream, the HHO stream, and the HCCO stream that can be obtained from the FCC primary fractionator 2025 and can be used to make up at least a portion of the make-up liquid stream in line 2015. In some embodiments, at least a portion of the make-up liquid stream in line 2015 can be removed via line 2031 from the process/system 2000.

In some embodiments, at least a portion of the SCGO in line 2011 can be recovered and removed via line 2023 from the process/system 2000. For example, at least a portion of the SCGO via line 2023 can be introduced into one or more hydroprocessors to produce a hydroprocessed product, e.g., diesel fuel.

As noted above, in some embodiments, at least a portion of the SCT stream via line 2013 can be fed into the coker primary fractionator 2035. A number of product streams can be recovered from the coker primary fractionator 2035. For simplicity and ease of description, an overhead stream via line 2037, a side stream via line 2039, and a bottoms stream via line 2041 are shown. The side stream in line 2039 represents any one or more of the HKN stream, the LKGO stream, and the HKGO stream that can be obtained from the coker primary fractionator 2035. In some embodiments, at least a portion of the side stream via line 2039 can be combined with the SCGO side stream in line 2011 to produce a mixture that can be introduced into the FCC reactor 2019 and/or removed via line 2023 from the process/system 2000. In other embodiments, the side-stream in line 2039 can be introduced downstream of line 2023 such that all the side stream in line 2039 can be introduced into the FCC reactor 2019.

In some embodiments, at least a portion of the side stream in line 2039 can be used to make up at least a portion or all of the make-up liquid stream introduced via line 2015 and/or 2018 into the steam cracker primary fractionator 2007. For example, at least a portion of the side stream in line 2039 can be combined via line 2043 with the make-up liquid stream in line 2015 to produce a combined make-up liquid stream and/or introduced via line 2018 into the steam cracker primary fractionator 2007. In some embodiments, at least a portion of the side stream via line 2043 can be combined with the steam cracker effluent in line 2005 to produce a mixture that can be introduced into the steam cracker primary fractionator 2007.

The bottoms stream via line 2041 can be introduced into a coker reactor 2045 to produce a coker product via line 2047 that can be recycled to the coker primary fractionator 2035 for separation that can be recovered via the overhead 2037 and/or the one or more side streams 2039. The coker reactor 2045 can indirectly heat the coker bottoms to produce a heated coker bottoms that can be introduced into a coking drum where the heated mixture can be allowed a sufficient residence time such that the hydrocarbon molecules can be broken into smaller hydrocarbon molecules to produce the coker product that can be recovered via line 2047.

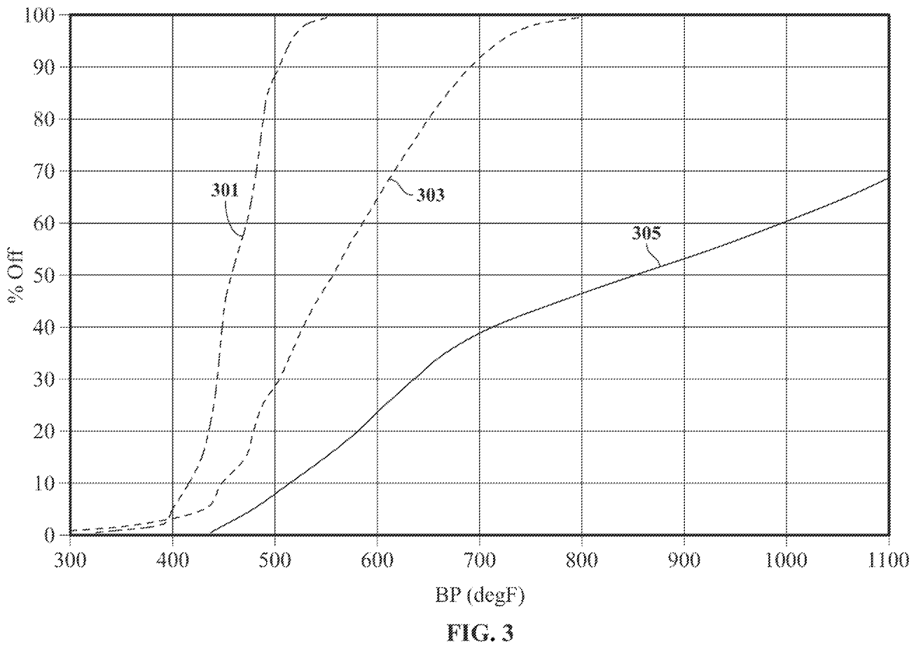

FIG. 3 shows exemplary boiling curves of a SCGO 301 obtained from a steam cracker primary fractionator, e.g., steam cracker primary fractionator 1007/2007, a LCO 303 obtained from a FCC primary fractionator, e.g., FCC primary fractionator 2025, and a SCT 305 obtained from a steam cracker primary fractionator, e.g., steam cracker primary fractionator 1007/2007. As shown in FIG. 3, a significant portion of the boiling curve of the LCO 303 overlaps with the SCGO 301 boiling curve and a significant portion of the boiling curve of the LCO 303 overlaps with the SCT 305 boiling curve. As such, when the make-up liquid stream in line 1015 and/or 2015 includes the LCO obtained from the FCC primary fractionator 2025, a first hydrocarbon portion from the make-up liquid stream 1015/2015 can be distributed into the SCGO side stream 1011/2011 and a second hydrocarbon portion from the make-up liquid stream 1015/2015 can distributed into the SCT steam 1013/2013. In some embodiments, when the make-up liquid stream in line 1015/2015 includes the LCO 303, at least 20 wt % of the make-up liquid stream 1015/2015 can be distributed into the SCGO side stream 1011/2011, based on the total weight of the make-up liquid stream and at least 30 wt % of the make-up liquid stream 1015/2015 can be distributed into the SCT stream 1013/2013, based on the total weight of the make-up liquid stream.

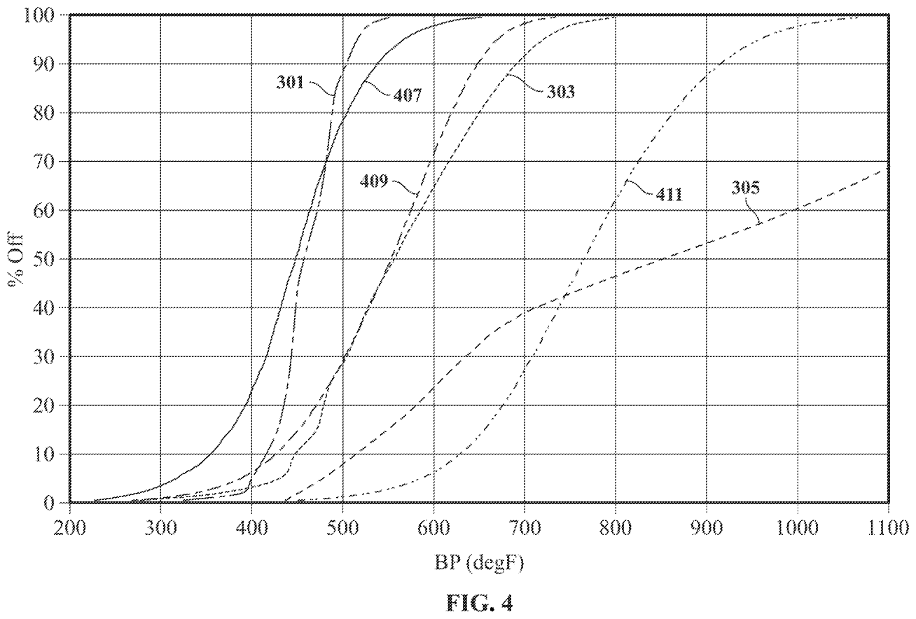

FIG. 4 shows exemplary boiling curves of the SCGO 301, the LCO 303, the SCT 305, a HKN 407, a LKGO 409, and a HKGO 411 obtained from a coker primary fractionator, e.g., coker primary fractionator 2035. As shown in FIG. 4, the boiling curve of the LKGO 409 is substantially similar to the boiling curve of the LCO 303. As also shown in FIG. 4, a significant portion of the boiling curve of the HKN 407 overlaps with the boiling curve of the SCGO 301 and a relatively smaller portion of the boiling curve of the HKN 407 overlaps with the boiling curve of the SCT 305. As also shown in FIG. 4, a significant portion of the boiling curve of the HKGO 411 overlaps with the boiling curve of the SCT 305 and a relatively smaller portion of the boiling curve of the HKGO 411 overlaps with the boiling curve of the SCGO 301. As such, when the make-up liquid stream in line 1015 and/or 2015 includes the HKN 407, the LKGO 409, and/or the HKGO 411 obtained from the coker primary fractionator 2035, a first hydrocarbon portion from the make-up liquid stream 1015/2015 can be distributed into the SCGO side stream 1011/2011 and a second hydrocarbon portion from the make-up liquid stream 1015/2015 can distributed into the SCT steam 1013/2013. In some embodiments, a blend of the HKN 407 and the HKGO 411 can be used to obtain a make-up liquid stream that can have boiling curve that more closely matches the boiling curves of the LCO 303 and the LKGO 409. In some embodiments, when the make-up liquid stream in line 1015/2015 includes the HKN 407, the LKGO 409, and/or the HKGO 411 obtained from the coker primary fractionator 2035, at least 20 wt % of the make-up liquid stream 1015/2015 can be distributed into the SCGO side stream 1011/2011, based on the total weight of the make-up liquid stream and at least 30 wt % of the make-up liquid stream 1015/2015 can be distributed into the SCT stream 1013/2013, based on the total weight of the make-up liquid stream.

In some embodiments, the make-up liquid stream in lines 1015 and/or 2015 can include one or more of the LCO 303, the HKN 407, the LKGO 409, and the HKGO 411. In some embodiments, when make-up liquid stream in lines 1015 and/or 2015 include two or more of the LCO 303, the HKN 407, the LKGO 409, and the HKGO 411, the weight ratios of the components making up the make-up liquid stream in line 1015 and/or 2015 can be adjusted to any suitable proportion. Additionally, when the make-up liquid stream in lines 1015 and/or 2015 include two or more of the LCO 303, the HKN 407, the LKGO 409, and the HKGO 411, the weight ratios of the components making up the make-up liquid stream can be adjusted during operation to cause the amount of the first hydrocarbon portion distributed into the SCGO side stream 1011/2011 and the amount of the second hydrocarbon portion distributed into the SCT stream 1013/2013 to change as process conditions can change, e.g., a composition of the hydrocarbon feed in line 1001 and/or 2001 changes, during operation of the process/systems 1000/2000.

In some embodiments, the process/system 2000 can include feeding the steam cracker effluent via line 2005 into the steam cracker primary fractionator 2007. In some embodiments, at least a portion of the SCGO side stream via line 2011 can be fed into the FCC reactor 2019. In some embodiments, at least a portion of the SCT stream via line 2013 can be fed into the coker primary fractionator 2035. In some embodiments, at least a portion of the SCGO side stream via line 2011 can be fed into the FCC reactor 2019 and at least a portion of the SCT stream via line 2013 can be fed into the coker primary fractionator 2035. In some embodiments, the process/system 2000 can also include introducing at least a portion of the side stream 2039 recovered from the coker primary fractionator 2035 into the FCC reactor 2019. As noted above, the side stream 2039 can be a HKN stream, a LKGO stream, and/or a HKGO stream. In some embodiments, at least a portion of the SCGO side stream via line 2011 can be fed into the FCC reactor 2019, at least a portion of the SCT stream via line 2013 can be fed into the coker primary fractionator 2035, and at least a portion of the side stream 2039 recovered from the coker primary fractionator 2035 can be fed into the FCC reactor 2019. In such embodiments, the make-up liquid stream via line 2015, and/or the liquid hydrocarbon feed via line 2018 can be introduced into the steam cracker primary fractionator 2007 or neither of the make-up feed via lines 2015 nor the liquid hydrocarbon feed via line 2018 can be introduced into the steam cracker primary fractionator 2007. In other words, introduction of any make-up via line 2015 feed or any liquid hydrocarbon feed via line 2018 into the steam cracker primary fractionator 2007 can be optional.

The steam cracking conditions in the steam crackers 1003/2003 can include, but are not limited to, one or more of: exposing the hydrocarbon feed introduced via line 1001/2001 to a temperature (as measured at a radiant outlet of the steam cracker) of ≥400° C., e.g., a temperature of about 700° C., about 800° C., or about 900° C. to about 950° C., about 1,000° C., or about 1050° C., a pressure of about 100 kPa-absolute to about 600 kPa-absolute, and/or a steam cracking residence time of about 0.01 seconds to about 5 seconds. In some embodiments, the steam cracker effluent in line 1005/2005, at an outlet of the radiant tube(s), can be at a temperature of ≥400° C., e.g., a temperature of about 700° C., about 800° C., or about 900° C. to about 950° C., about 1,000° C., or about 1050° C. Suitable steam crackers, product recovery configurations, other equipment, and process conditions can include those disclosed in U.S. Pat. Nos. 6,419,885; 7,560,019; 7,993,435; 8,105,479; 8,197,668; 8,882,991; 9,637,694; 9,777,227; U.S. Patent Application Publication Nos.: 2014/0061096; 2014/0357923; 2016/0376511; 2018/0170832; 2019/0016975; and WO Publication No.: WO 2018/111574; WO/2020/096972; WO/2020/096974; WO/2020/096977; and WO/2020/096979.

In the FCC reactor 2019, the hydrocarbon feed(s) via line 2011 and/or 2017 can be contacted with a plurality of fluidized catalyst particles for a contact time therein. The hydrocarbon feed(s) can be injected through one or more feed nozzles into a reactor riser. Within this reactor riser, the hydrocarbon feed(s) can be contacted with a catalytic cracking catalyst under cracking conditions thereby resulting in spent catalyst particles containing coke deposited thereon and a lower boiling product stream. In some embodiments, the cracking conditions can include: temperatures from 538° C. to 816° C.; a hydrocarbon partial pressure from about 70 kPa-a to about 345 kPa-a; and a catalyst to feed (wt/wt) ratio from 2 to 10. In some embodiments, steam can be concurrently introduced with the feed into the reaction zone. The steam can make up to about 5 wt % of the hydrocarbon feed(s) introduced into the FCC reactor. in some embodiments, the residence time in the reaction zone can be less than about 5 seconds, e.g., from about 2 to about 3 seconds. Suitable FCC reactors, product recovery configurations, other equipment, and process conditions can include those disclosed in Handbook of Petroleum Refining Processes, 2d Ed., R. A. Meyers, 3.3-3.111, McGraw-Hill and U.S. Patent Application Publication No. 2011/0220549.

The coker conditions can include: heating the bottoms in line 2041 to a temperature of 470° C. to 550° C. and a residence time in the coking drum of from 1 minutes to 500 minutes. In some embodiments, the HKN stream, the LKGO stream, and the HKGO stream that can be obtained via line(s) 2039 from the coker primary fractionator 2035 can be at a temperature in a range of 160° C. to 195° C., a temperature in a range of 230° C. to 270° C., and a temperature in a range of 320° C. to 360° C., respectively. Any type of coker known in the art may be used under operation conditions one skilled in the art are familiar with. The specific type of coker is not critical.

### Simulated Example

An example economic analysis for the implementation of this integrated cracking process is summarized in Tables 1-3 below. A generic price set (c/lbs) was used that is representative of US Gulf Coast pricing. Only the feeds being impacted by this invention are shown in the analysis (feed and products not changing between the different cases are not shown). Here it is assumed that through importing LCO from a FCC to the steam cracker primary fractionator and exporting tar to a coker, gas oil feed (PGO) to the steam cracker can be offset with natural gas liquids (NGL). Specifically for this analysis, NGL is chosen to be butane. The three cases considered are summarized below.

Case 1: Base Case Feed and Process Configuration—This case represents operation without implementation of the integrated cracking process. The steam cracker feed consists of 55 klb/hr of PGO and 100 klb/hr of butane. SCGO is exported to slop sales and tar is sold to a marine fuels (bunker fuel) tier.

Case 2: Base Case Feed and Integrated Cracking Process Implementation—The feed basis is the same as Case 1, but the Integrated Cracking Process is implemented. No LCO is imported, but SCGO is sent to the FCC and tar is routed to the coker fractionator. As seen in the “FCC Products from SCGO” section of Table 1, most of the SCGO yields gasoline and LCO, with very little light products produced. SCGO has relatively low conversion through the FCC, so most of the molecules simply fractionate with heavy naphtha and LCO. Of the SCGO molecules that do react through the FCC reactor, a significant portion produces highly aromatic gasoline by cleaving sidechains from single ring aromatics. The coker recovers much of the tar as LKGO and HKGO, and there is some conversion of the remaining resid to coker naphtha (HKN). Even though there is no change to the steam cracker feed, the economics of this integrated configuration are quite strong ($11 MM/yr) due to improved gas oil recovery.

Case 3: Optimized Feed with Integrated Cracking Process Implementation—This case represents the process configuration presented in Case 2, with the added benefit of displacing the PGO feed to the steam cracker with NGL. Specifically, 55 klb/hr of PGO is exchanged for 55 klb/hr of butane feed. LCO is imported to the steam cracker primary fractionator at a rate of 35 klb/hr to stabilize operation. As a result of importing LCO, SCGO production increases substantially from 3.6 klb/hr to 21.1 klb/hr. Tar production increase slightly from 12.2 klb/hr to 14.1 klb/hr. Although the tar production increase appears modest, it should be noted that the tar consists primarily of LCO molecules in Case 3. In Case 1 and 2, the tar rate was primarily due to PGO feed, as PGO is known to have a large tar yield. Case 3 has no feed PGO and NGL yields very little tar, so most of the tar rate actually represents the heavier portion of the LCO distillation curve.

The economics of Case 3 are improved from Case 2 by $5MM/yr, despite having a higher SCGO and tar production rate, which are often viewed as low value products. Case 3 produces more ethylene (+3.3 klb/hr) with a cheaper feed source (11.1 c/lb for butane vs 15.3 c/lb for PGO). Of course, utilizing the cheaper feed was only possible by importing significant quantities of LCO, which is even more valuable than PGO at 18.2 c/lb. However, due to the integrated process configuration, the valuable LCO molecules are recovered to a high value fuels disposition, so there is minimal economic penalty for importing LCO.

TABLE 1

| | | | Case | | |
|---|---|---|---|---|---|
| | | | 1 | 2 | 3 |
| | | | Base Case Feed & | Base Case Feed & | Zero Heavy Liquid |
| | | | Existing | New Steam | Feed & New Steam |
| | | Value | Process | Cracker/FCC/Coker | Cracker/FCC/Coker |
| Description | | (c/lb) | Configuration | Integration | Integration |
| Feeds to | PGO | 15.3 | 55 | 55 | 0 |
| Steam | (klb/hr) | | | | |
| Cracker | NGL | 11.1 | 100 | 100 | 155 |
| | (klb/hr) | | | | |
| | LCO | 18.2 | 0 | 0 | 35 |
| | (klb/hr) | | | | |
| Olefin | Fuel Gas | 5.4 | 20.7 | 20.7 | 25.8 |
| Products | (klb/hr) | | | | |
| | Ethane | 7.8 | 8.3 | 8.3 | 9.2 |
| | (klb/hr) | | | | |
| | Ethylene | 17.3 | 25.5 | 25.5 | 28.8 |
| | (klb/hr) | | | | |
| | Propane | 11.5 | 1.2 | 1.2 | 1 |
| | (klb/hr) | | | | |
| | Propylene | 15.5 | 29.1 | 29.1 | 35.2 |
| | (klb/hr) | | | | |
| | Butane | 11.1 | 20.1 | 20.1 | 31 |
| | (klb/hr) | | | | |
| | Butadiene | 9 | 3.5 | 3.5 | 2.7 |
| | (klb/hr) | | | | |
| | Butylenes | 27.6 | 8.8 | 8.8 | 8.8 |
| | (klb/hr) | | | | |
| | Aromatics | 18.3 | 5.2 | 5.2 | 3.3 |
| | (klb/hr) | | | | |
| | SCGO | See | 3.6 | 3.6 | 21.1 |
| | (klb/hr) | Below | | | |
| | SCN | 17.5 | 16.7 | 16.7 | 8.9 |
| | (klb/hr) | | | | |
| | SCT | See | 12.2 | 12.2 | 14.1 |
| | (klb/hr) | Below | | | |

TABLE 2

| | | | Case | | |
|---|---|---|---|---|---|
| | | | 1 | 2 | 3 |
| | | | Base Case Feed & | Base Case Feed & | Zero Heavy Liquid |
| | | | Existing | New Steam | Feed & New Steam |
| | | Value | Process | Cracker/FCC/Coker | Cracker/FCC/Coker |
| Description | | (c/lb) | Configuration | Integration | Integration |
| SCGO | SCGO to | 8 | 3.6 | 0 | 0 |
| Disposition | slop | | | | |
| | (klb/hr) | | | | |
| | SCGO to | See | 0 | 3.6 | 21.1 |
| | FCC Feed | Below | | | |
| | (klb/hr) | | | | |
| Tar | Tar to Sales | 8 | 12.2 | 0 | 0 |
| Disposition | (klb/hr) | | | | |
| | Tar to | See | 0 | 12.2 | 14.1 |
| | Coker | Below | | | |
| | Fractionator | | | | |
| | (klb/hr) | | | | |
| FCC | Fuel Gas | 5.4 | 0 | 0.1 | 0.4 |
| Products | (klb/hr) | | | | |
| from | Ethane | 7.8 | 0 | 0 | 0.3 |
| SCGO | (klb/hr) | | | | |
| | Ethylene | 17.3 | 0 | 0 | 0.2 |
| | (klb/hr) | | | | |
| | Propane | 11.5 | 0 | 0.1 | 0.5 |
| | (klb/hr) | | | | |
| | Propylene | 15.5 | 0 | 0.3 | 1.7 |
| | (klb/hr) | | | | |
| | Butane | 11.1 | 0 | 0 | 0.2 |
| | (klb/hr) | | | | |
| | Isobutane | 14.8 | 0 | 0.1 | 0.7 |
| | Butylenes | 27.6 | 0 | 0.3 | 1.9 |
| | (klb/hr) | | | | |
| | Light Cat | 18.2 | 0 | 0.8 | 4.6 |
| | Cycle Oil | | | | |
| | (klb/hr) | | | | |
| | Gasoline | 17.5 | 0 | 1.8 | 10.6 |
| | (klb/hr) | | | | |

TABLE 3

| | | | Case | | |
|---|---|---|---|---|---|
| | | | 1 | 2 | 3 |
| | | | Base Case Feed & | Base Case Feed & | Zero Heavy Liquid |
| | | | Existing | New Steam | Feed & New Steam |
| | | Value | Process | Cracker/FCC/Coker | Cracker/FCC/Coker |
| Description | | (c/lb) | Configuration | Integration | Integration |
| Coker | HKN | 15.3 | 0 | 1.2 | 1.4 |
| Products | (klb/hr) | | | | |
| from Tar | LKGO | 15.3 | 0 | 9.8 | 11.3 |
| | (klb/hr) | | | | |
| | HKGO | 15.3 | 0 | 1.2 | 1.4 |
| | (klb/hr) | | | | |
| Economics | Cost | | 468 | 468 | 566 |
| | (k$/day | | | | |
| | Value | | 503 | 533 | 645 |
| | (k$/day) | | | | |
| | Net | | 34 | 64 | 79 |
| | Incentive | | | | |
| | Per Case | | | | |
| | (k$/day) | | | | |
| | Delta vs | | | 11 | 16 |
| | Case 1 | | | | |
| | ($M/yr) | | | | |

This disclosure may further include the following non-limiting embodiments.

A1. A system, comprising: (I) a steam cracker furnace comprising a steam cracker effluent outlet; (II) a steam cracker primary fractionator having an inlet in fluid communication with the steam cracker effluent outlet configured to receive a steam cracker effluent produced in the steam cracker furnace, wherein the steam cracker primary fractionator comprises a steam cracker gas oil side stream outlet configured to convey a steam cracker gas oil therethrough, and wherein the steam cracker primary fractionator comprises a steam cracker tar outlet located at and/or in the vicinity of a bottom of the steam cracker primary fractionator configured to convey a steam cracker tar therethrough; and (III) a make-up liquid conduit in fluid communication with the steam cracker primary fractionator, wherein the make-up liquid conduit is configured to convey a make-up liquid stream into the steam cracker primary fractionator.

A2. The system of A1, wherein the steam cracker gas oil side stream outlet is configured to convey at least a portion of the steam cracker gas oil into a fluidized catalytic cracker reactor.

A3. The system of A1 or A2, wherein the steam cracker tar outlet is configured to convey the steam cracker tar into a coker primary fractionator.

A4. The system of A3, wherein the coker primary fractionator comprises one or more coker liquid side stream outlets, and wherein at least one of the one or more coker liquid side stream outlets is configured to convey a coker liquid side stream into a fluidized catalytic cracker reactor.

A5. The system of A3, wherein the coker primary fractionator comprises one or more coker liquid side stream outlets, and wherein at least one of the one or more coker liquid side stream outlets is configured to convey a coker liquid side stream into the steam cracker primary fractionator via the make-up liquid conduit.

A6. The system of any one of A1 to A4, wherein the make-up liquid stream is obtained from a fluidized catalytic cracker primary fractionator.

A7. The system of A6, wherein the make-up liquid stream comprises an ultra-light cycle oil stream, a light cycle oil stream, a heavy cycle oil stream, a heavy heating oil stream, a heavy catalytic cycle oil stream, or a mixture thereof.

A8. The system of A1 or A2, wherein the make-up liquid stream is obtained from a coker primary fractionator.

A9. The system of A8, wherein the make-up liquid stream comprises a heavy coker naphtha stream, a light coker gas oil stream, a heavy coker gas oil stream, or a mixture thereof.

A10. The system of A1, wherein the make-up liquid stream comprises a heavy aromatic reformate recovered from a reformer effluent.

B1. A process, comprising: (I) feeding a steam cracker effluent into a steam cracker primary fractionator; (II) recovering a steam cracker gas oil (“SCGO”) side stream from the steam cracker primary fractionator; (III) recovering a steam cracker tar (“SCT”) stream from a location at and/or in the vicinity of a bottom of the steam cracker primary fractionator; and (IV) feeding at least a portion of the SCGO side stream into a fluidized catalytic (“FCC) reactor and/or feeding at least a portion of the SCT stream into a coker primary fractionator.

B2. The process of B1, wherein step (IV) includes feeding the at least a portion of the SCGO side stream into the FCC reactor and feeding the at least a portion of the SCT stream into the coker primary fractionator.

B3. The process of B1 or B2, further comprising (V) feeding a side stream recovered from the coker primary fractionator into the FCC reactor.

B4. The process of B3, wherein the side steam comprises heavy coker naphtha, light coker gas oil, heavy coker gas oil, or a combination thereof.

B5. The process any one of B1 to B4, further comprising (VI) feeding a make-up liquid stream into the steam cracker primary fractionator.

B6. The process of B5, wherein the make-up liquid stream comprises a first hydrocarbon portion and a second hydrocarbon portion, the first hydrocarbon portion is distributed into the SCGO side stream, and the second hydrocarbon portion is distributed into the SCT stream.

B7. The process of B5 or B6, wherein the make-up liquid stream is fed into the steam cracker primary fractionator at a location above the first steam cracker effluent.

B8. The process of any one of B5 to B7, wherein: at least 20 wt % of the make-up liquid stream is distributed into the SCGO side stream, based on the total weight of the make-up liquid stream, and at least 30 wt % of the make-up liquid stream is distributed into the SCT stream, based on the total weight of the make-up liquid stream.

B9. The process of any one of B5 to B8, wherein the make-up liquid stream comprises, based on the total weight of the make-up liquid stream: from 10 wt % to 30 wt % of hydrocarbon molecules having normal boiling points from 145° C. to 260° C.; and from 10 wt % to 40 wt % of hydrocarbon molecules having normal boiling points >340° C.

B10. The process of any one of B5 to B9, wherein the make-up liquid stream comprises: >80 wt % of hydrocarbon molecules having normal boiling points in a range from 200° C. to 485° C.; and/or 25 wt % to 80 wt % of hydrocarbons having normal boiling points in the range from 260° C. to 345° C.

B11. The process of any one of B5 to B10, wherein the make-up liquid stream comprises any of the following or a mixture of any two or more of the following: an ultra-light cycle oil (“ULCO”) stream obtained from a fluidized catalytic cracker (“FCC”) primary fractionator, a light cycle oil (“LCO”) stream obtained from a FCC primary fractionator, a heavy cycle oil (“HCO”) stream obtained from a FCC primary fractionator, a heavy heating oil (“HHO”) stream obtained from a FCC primary fractionator, a heavy catalytic cycle oil (“HCCO”) stream obtained from a FCC primary fractionator, a heavy coker naphtha (“HKN”) stream obtained from a coker primary fractionator, a light coker gas oil (“LKGO”) stream obtained from a coker primary fractionator, a heavy coker gas oil (“HKGO”) stream obtained from a coker primary fractionator, and a heavy aromatic reformate (“HAR”) stream obtained from a reformer effluent.

C1. A system, comprising: (I) a steam cracker furnace comprising a steam cracker effluent outlet; (II) a steam cracker primary fractionator having an inlet in fluid communication with the steam cracker effluent outlet configured to receive a steam cracker effluent produced in the steam cracker furnace, wherein the steam cracker primary fractionator comprises a steam cracker gas oil side stream outlet configured to convey a steam cracker gas oil therethrough, and wherein the steam cracker primary fractionator comprises a steam cracker tar outlet located at and/or in the vicinity of a bottom of the steam cracker primary fractionator configured to convey a steam cracker tar therethrough; and (III) a fluidized catalytic reactor having an inlet in fluid communication with the steam cracker gas oil side stream outlet or (IV) a coker primary fractionator having an inlet in fluid communication with the steam cracker tar outlet.

C2. The system of C1, wherein the system comprises the fluidized catalytic reactor having the inlet in fluid communication with the steam cracker gas oil side stream outlet and the coker primary fractionator having the inlet in fluid communication with the steam cracker tar outlet.

C3. The system of C1 or C2, wherein the steam cracker primary fractionator comprises a side stream outlet in fluid communication with the inlet of the fluidized catalytic reactor.

C4. The system of any one of C1 to C3, further comprising (V) a make-up liquid conduit in fluid communication with the steam cracker primary fractionator, wherein the make-up liquid conduit is configured to feed a make-up liquid stream into the steam cracker primary fractionator.

C5. The system of C4, wherein the make-up liquid stream conduit is configured to feed a FCC cycle oil stream obtained from a fluidized catalytic cracker primary fractionator into the steam cracker primary fractionator, wherein the fluidized catalytic cracker primary fractionator is configured to receive a fluidized catalytic cracker effluent produced in the fluidized catalytic cracker.

C6. The system of C4 or C5, wherein the make-up liquid stream conduit is configured to feed a side stream obtained from the coker primary fractionator into the steam cracker primary fractionator.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process, comprising:
(I) feeding a first steam cracker effluent into a steam cracker primary fractionator;
(II) feeding a make-up liquid stream into the steam cracker primary fractionator;
(III) recovering a steam cracker gas oil (“SCGO”) side stream from the steam cracker primary fractionator; and
(IV) recovering a steam cracker tar (“SCT”) stream from a location at and/or in the vicinity of a bottom of the steam cracker primary fractionator, wherein:
the make-up liquid stream comprises a first hydrocarbon portion and a second hydrocarbon portion,
the first hydrocarbon portion is distributed into the SCGO side stream, and
the second hydrocarbon portion is distributed into the SCT stream.

2. The process of claim 1, wherein the make-up liquid stream is fed into the steam cracker primary fractionator at a location above the first steam cracker effluent.

3. The process of claim 1, wherein:
at least 20 wt % of the make-up liquid stream is distributed into the SCGO side stream, based on the total weight of the make-up liquid stream, and
at least 30 wt % of the make-up liquid stream is distributed into the SCT stream, based on the total weight of the make-up liquid stream.

4. The process of claim 1, wherein the make-up liquid stream comprises, based on the total weight of the make-up liquid stream:
from 10 wt % to 30 wt % of hydrocarbon molecules having normal boiling points from 145° C. to 260° C.; and
from 10 wt % to 40 wt % of hydrocarbon molecules having normal boiling points >340° C.

5. The process of claim 1, wherein the make-up liquid stream comprises:
≥80 wt % of hydrocarbon molecules having normal boiling points in a range from 200° C. to 485° C.; and/or
25 wt % to 80 wt % of hydrocarbons having normal boiling points in the range from 260° C. to 345° C.

6. The process of claim 1, wherein the make-up liquid stream comprises any of the following or a mixture of any two or more of the following:
an ultra-light cycle oil (“ULCO”) stream obtained from a fluidized catalytic cracker (“FCC”) primary fractionator,
a light cycle oil (“LCO”) stream obtained from a FCC primary fractionator,
a heavy cycle oil (“HCO”) stream obtained from a FCC primary fractionator,
a heavy heating oil (“HHO”) stream obtained from a FCC primary fractionator,
a heavy catalytic cycle oil (“HCCO”) stream obtained from a FCC primary fractionator,
a heavy coker naphtha (“HKN”) stream obtained from a coker primary fractionator,
a light coker gas oil (“LKGO”) stream obtained from a coker primary fractionator,
a heavy coker gas oil (“HKGO”) stream obtained from a coker primary fractionator, and
a heavy aromatic reformate (“HAR”) stream obtained from a reformer effluent.

7. The process of claim 1, further comprising:
(V) feeding at least a portion of the SCGO side stream into a FCC;
(VI) obtaining a FCC effluent;
(VII) separating the FCC effluent to obtain a FCC cycle oil stream; and
(VIII) providing the FCC cycle oil stream as at least a portion of the make-up liquid stream in step (II).

8. The process of claim 1, further comprising:
(IX) feeding at least a portion of the SCT stream into a coker primary fractionator;
(X) obtaining a coker gas oil stream from the coker primary fractionator; and
(XI) providing at least a portion of the coker gas oil stream as at least a portion of the make-up liquid stream in step (II).

9. The process of claim 1, wherein the steam cracker primary fractionator is configured to require a minimum SCGO side stream production rate and a minimum SCT stream production rate, and wherein the first steam cracker effluent alone is incapable of achieving the minimum SCGO side stream production rate and/or the minimum SCT stream production rate.

10. The process claim 9, wherein the first steam cracker effluent is produced by steam cracking a C₄₋ hydrocarbon feed.

11. The process of claim 9, wherein the primary fractionator is originally designed to process a first steam cracker effluent produced by steam cracking a liquid hydrocarbon feed.

12. The process of claim 1, further comprising:
(XII) stopping the feeding of the first steam cracker effluent into the steam cracker primary fractionator;
(XIII) feeding a second steam cracker effluent into the steam cracker primary fractionator, wherein the second steam cracker effluent has different amounts of SCGO and SCT compared to the first steam cracker effluent; and
(XIV) adjusting the amount of the make-up liquid stream in step (II) to maintain stable operation of the steam cracker primary fractionator.

13. The process of claim 12, wherein in step (XIII), the feeding of the second steam cracker effluent is capable of achieving the minimum SCGO side stream production rate and the minimum SCT stream production rate, and step (XIV) comprises reducing the amount of the make-up liquid stream in step (II) to zero.

14. A process comprising:
(1) feeding a first steam cracker effluent produced by steam cracking a first hydrocarbon feed into a steam cracker primary fractionator capable of processing a second steam cracker effluent produced by steam cracking a second hydrocarbon feed, wherein the second hydrocarbon feed is heavier than the first hydrocarbon feed;
(2) feeding a make-up liquid stream into the steam cracker primary fractionator;
(3) recovering a steam cracker gas oil (“SCGO”) side stream from the steam cracker primary fractionator; and
(4) recovering a steam cracker tar (“SCT”) stream from a location at and/or in the vicinity of a bottom of the primary fractionator, wherein:
the make-up liquid stream comprises a first hydrocarbon portion and a second hydrocarbon portion,
the first hydrocarbon portion is distributed into the SCGO side stream, and
the second hydrocarbon portion is distributed into the SCT stream.

15. The process of claim 14, wherein the make-up liquid stream is fed into the steam cracker primary fractionator at a location above the first steam cracker effluent.

16. The process of claim 14, wherein:
at least 20 wt % of the make-up liquid stream is distributed into the SCGO side stream, based on the total weight of the make-up liquid stream, and
at least 30 wt % of the make-up liquid stream is distributed into the SCT stream, based on the total weight of the make-up liquid stream.

17. The process of claim 14, wherein the make-up liquid stream comprises, based on the total weight of the make-up liquid stream:
from 10 wt % to 30 wt % of hydrocarbon molecules having normal boiling points from 145° C. to 260° C.; and
from 10 wt % to 40 wt % of hydrocarbon molecules having normal boiling points >340° C.

18. The process of claim 14, further comprising:
(5) feeding at least a portion of the SCGO side stream into a fluidized catalytic cracker (“FCC”);
(6) obtaining a FCC effluent;
(7) separating the FCC effluent to obtain a FCC cycle oil stream; and
(8) providing the FCC cycle oil stream as at least a portion of the make-up liquid stream in step (2).

19. The process of claim 14, further comprising:
(9) feeding at least a portion of the SCT stream into a coker primary fractionator;
(10) obtaining a coker gas oil stream from the coker primary fractionator; and
(11) providing at least a portion of the coker gas oil stream as at least a portion of the make-up liquid stream in step (2).

20. A process, comprising:
(i) feeding a first steam cracker effluent into a steam cracker primary fractionator;
(ii) feeding a make-up liquid stream into the steam cracker primary fractionator, preferably at a location above the first steam cracker effluent, wherein the make-up liquid stream comprises a first hydrocarbon portion and a second hydrocarbon portion heavier than the first hydrocarbon portion;
(iii) recovering a steam cracker gas oil (“SCGO”) side stream comprising the first hydrocarbon portion from the steam cracker primary fractionator;
(iv) recovering a steam cracker tar (“SCT”) stream comprising the second hydrocarbon portion from a location at and/or in the vicinity of a bottom of the steam cracker primary fractionator;
(v) feeding at least a portion of the SCGO side stream into a fluidized catalytic cracker (“FCC”);
(vi) recovering a FCC effluent from the FCC;
(vii) separating the FCC effluent to obtain a FCC cycle oil stream; and
(viii) providing at least a portion of the FCC cycle oil stream as at least a portion of the make-up liquid stream in step (ii).

21. The process of claim 20, further comprising:
(ix) feeding at least a portion of the SCT stream into a coker primary fractionator;
(x) obtaining a coker gas oil stream from the coker primary fractionator; and
(xi) feeding at least a portion of the coker gas oil stream into the FCC.

22. The process of claim 20, wherein:
at least 20 wt % of the make-up liquid stream is distributed into the SCGO side stream, based on the total weight of the make-up liquid stream, and
at least 30 wt % of the make-up liquid stream is distributed into the SCT stream, based on the total weight of the make-up liquid stream.

23. The process of claim 20, wherein the make-up liquid stream comprises, based on the total weight of the make-up liquid stream:
from 10 wt % to 30 wt % of hydrocarbon molecules having normal boiling points from 145° C. to 260° C.; and
from 10 wt % to 40 wt % of hydrocarbon molecules having normal boiling points >340° C.

24. The process of claim 20, wherein the make-up liquid stream comprises:
≥80 wt % of hydrocarbon molecules having normal boiling points in a range from 200° C. to 485° C.; and/or
25 wt % to 80 wt % of hydrocarbons having normal boiling points in the range from 260° C. to 345° C.

25. The process of claim 20, wherein the FCC cycle oil stream is a FCC light cycle oil (“LCO”) stream.
